(19) United States
(12) Patent Application Publication
(10) Pub. No.: US 2014/0317497 A1
(43) Pub. Date: Oct. 23, 2014

(54) Method, Apparatus and System for Changing Font for Application Program

(71) Applicants: Beijing Founder Electronics Co., Ltd., Beijing (CN); Peking University Founder Group Co., Ltd., Beijing (CN)

(72) Inventors: Fang Liu, Beijing (CN); Yujun Gao, Beijing (CN); Chang'an Yang, Beijing (CN)

(73) Assignees: Beijing Founder Electronics Co., Ltd., Beijing (CN); Peking University Founder Group Co., Ltd., Beijing (CN)

(21) Appl. No.: 14/095,174

(22) Filed: Dec. 3, 2013

(30) Foreign Application Priority Data
Apr. 19, 2013 (CN) 201310138215.5

(51) Int. Cl. G06F 17/21

(52) U.S. Cl. CPC G06F 17/214
USPC 715/269

(57) ABSTRACT

The application relates to the field of computer technology and discloses methods, client apparatus, and systems for changing a font for an application program. Methods can include: sending a request for obtaining information on available font resources to a server when it is need to change a font for an application program; presenting the information on the currently available font information resources after receiving the same from the server; determining a font selected by a user; downloading the selected font from the server; and sending the downloaded font to the application program, so that the application program replaces the currently used font with the downloaded font. Therefore, it is possible to change the font for the application program simply and expediently.

### CROSS-REFERENCE TO RELATED APPLICATIONS

The present application claims priority to Chinese Patent Application No. 201310138215.5 filed before the Chinese Patent Office on Apr. 19, 2013 and entitled “METHOD, APPARATUS AND SYSTEM FOR CHANGING FONT FOR APPLICATION PROGRAM”, which is incorporated herein by reference in its entirety.

### TECHNICAL FIELD

The present application relates to the field of computer technology, especially to a methods, apparatus and systems for changing a font for an application program.

### BACKGROUND

Along with the gradual increase in using mobile phones of Android system, the number of application programs running in the Android system increases and requirements for esthetic appearance and personalization of application programs have risen sharply as well. Whereas, the fonts utilized in the application program is an important constituent of the esthetic appearance and personalization.

In the prior art, the font utilized in the application program is set by the program developing staff, which cannot be changed by the user, therefore, it cannot satisfy the users' personalization requirements.

### SUMMARY

Innovative aspects of the disclosed subject matter include methods apparatus, and systems for changing a font for an application program, which can change the font for the application program easily and expediently.

For this purpose, the innovative aspects provide the following technical solutions.

In one aspect, a method for changing a font for an application program can include: sending a request for obtaining information on available font resources to a server when it is need to change a font for an application program; presenting the information on the currently available font information resources after receiving the same from the server; determining a font selected by a user; downloading the selected font from the server; and sending the downloaded font to the application program, so that the application program replaces the currently used font with the downloaded font.

Preferably, the request can include information on font resources that a client currently has.

Preferably, the information on the font resources that the client currently has is a version number of the font resources that the client currently has.

Preferably, the information on the currently available font resources include currently available font style, font typesetting effect and recommended scenes, and the presenting can include presenting the font style and the font typesetting effect by using a section of characters in a small character database extracted from the current character database, the section of characters contains the recommended scenes.

Preferably, the downloading can include downloading the selected font from the server by starting up a thread at back stage, and managing the downloaded information as a temporary file.

Preferably, the method further includes sending the information on the currently available font resources to other application programs by broadcast.

In one aspect of the present invention, a client apparatus can include: a request sending module, configured to send a request for obtaining information on available font resources to a server when it is need to change a font for an application program; a font information receiving module, configured to receive the information on the currently available font resources returned from the server; a font presenting module, configured to presenting the information on the currently available font resources after the font information receiving module receives the information on the currently available font resources returned from the server; a selection information obtaining module, configured to determine a font selected by a user; a font download module, configured to download the selected font from the server; and a font management module, configured to sending the downloaded font downloaded by the font downloading module to the application program, so that the application program replaces the currently used font with the downloaded font.

Preferably, the information on the currently available font resources include currently available font style, font typesetting effect and recommended scenes, and the font presenting module presents the font style and the font typesetting effect by using a section of characters in a small character database extracted from the current character database, the section of characters contains the recommended scenes,

Preferably, the font downloading module downloads the selected font from the server by starting up a thread at back stage, and manages the downloaded information as a temporary file.

Preferably, the font management module is further configured to send the currently available font resources received by the font information receiving module to other application programs by broadcast.

In one aspect of the present invention, a system for changing a font for an application program can include a client apparatus and a server, wherein the server is configured to receive a request for obtaining information on available font resources sent by the client apparatus, and send the information on the currently available font resources to the client apparatus after receiving the request, and the client apparatus is any one of the client apparatus foregoing.

In one aspect of the present invention, a computer program product can include computer code for implementing the method mentioned above.

In one aspect of the present invention, a storage medium is configured to store aforesaid computer program product.

The present invention provides a method, a client apparatus and a system for changing a font for an application program. When it is need to change a font for an application program, the client sends a request for obtaining information on available font resources to the server, presents the information on the currently available font resources after receiving the information on the currently available font resources returned from the server, obtains a font selected by a user, downloads the selected font from the server, sends the downloaded font to the application program, so that the application program replaces the currently used font with the downloaded font. Therefore, it is convenient to changes a font for the application program as needed at any moment.

Besides, by controlling the update and issue of the font resources by the server, the application program does not need to contain and manage the font resources. The Server may update the available font resources as needed at any moment, which provides the application program with more font resources and better user experiences.

Furthermore, the feature of low coupling of the method, the apparatus and system of the present invention makes it is possible for multiple application programs to share the method, the apparatus and system, which can save equipment resources and be convenient to manage them centrally.

### BRIEF DESCRIPTION OF THE DRAWINGS

In order to illustrate the aspects of the present application or technical solutions in the prior art more clearly, in the following, a brief introduction to the appended drawings which will be used in the description will be made. The drawings described below are only used for purposes of illustration, for a person skilled in the art, other drawings can be obtained according to these ones.

FIG. 1 is a flow chart illustrating an example method for changing a font for an application program.

FIG. 2 is a structural schematic illustrating an example client apparatus.

FIG. 3 is a structural schematic illustrating an example system for changing a font for an application program.

### DETAILED DESCRIPTION

In order to make a person skilled in the art to understand the disclosed subject matter better, in the following, a further detailed illustration will be made with reference to the appended drawings.

In methods for changing a font for an application program, in a server, multiple fonts are selected to constitute a set of available fonts, so as to satisfy different wording requirements in different scenes for various application programs. In addition, update and issue of font resources are controlled by the server. In one hand, this makes the application program not need to carry and manage font resources, which reduces the application program's burden; on the other hand, while the font resources need to be updated, this can be completed in the server conveniently, so as to update the font resources without updating the edition of the application program, which reduces the iteration cost of the application program and provides better user experiences.

Specifically, the font resource may include contents, such as the number of available fonts, font names, characters, pictures and small character library used to present the fonts, font files and so on. While the server selects the fonts to constitute the set of the fonts, it should be guaranteed that the types of fonts are abundant and the styles of fonts are representative and complementary, so as to satisfy various different of certain font requirements.

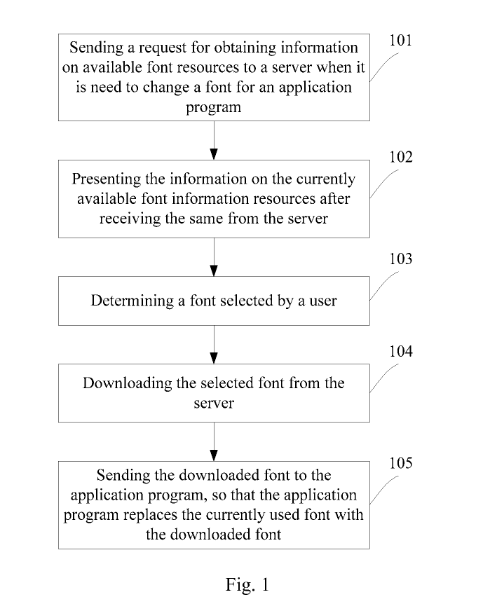

As shown in FIG. 1, it is a flow chart of an example method for changing a font for an application program according to one embodiment of the present invention, and the method can include the following steps.

In step 101, when it is need to change a font for an application program, a client sends a request for obtaining information on available font resources to a server.

The request may contain information on font resources that the client currently has. Before the server issues the information on available font resources to the client, the server determines whether there is new currently available font resources need to be issued to the client according to the information on the font resources that the client currently has. If yes, the server issues only the new font resources to the client; if no, the server notifies the client that there is no the new currently available font resources. In this way, it is possible to avoid repeatedly issuing the font resources that the client has, which saves the network traffic and the loading duration, and improves the user experiences.

The request may contain information on the version number of the font resources that the client currently has, which is used as an identifier of the font resources that the client currently has.

In step 102, the client presents the information on the currently available font resources after receiving the same from the server.

The information on the currently available font resources may include font style, font typesetting effect, recommended scenes for the font, etc. A method of presenting the information is not to present pictures but to directly present characters by using a small character library extracted from the current character library.

For instance, a section of characters in the small character library can be used to present the font style and the font typesetting effect, and the section of characters contain the recommended scenes.

Of course, other presenting methods can be adopted as well, and the presented content is not limited to the above mentioned information.

In step 103, the client determines a font selected by a user.

Specifically, while presenting the information on the currently available font resources, a selection mode should be presented to the user at the same time, the user selects a desired font according to his preferences. For instance, a selection button is provided corresponding to each font, of course, other available way is to allow a user to click the selected character by a mouse directly. Certainly, there should be other selection modes.

In step 104, the client downloads the selected font from the server.

The download of the font may support resuming of file transfers. And during the download, the equipment at the client side can still process other operations without being locked in a wait mode.

Specifically, one way to support resuming of file transfers is to manage the downloaded information as a temporary file.

In a download method, a new thread is started up to process the download at the back stage, so that the equipment may not be locked in the wait mode.

In step 105, the client sends the downloaded font to the application program, so that the application program can replace the currently used font with the downloaded font.

It should be noted that, in practical applications, after downloading the selected font from the server, the information on the currently available font resources could also be sent to other application programs that are interested in the change of font resources. For instance, the information on the currently available font resources is sent to other application programs by a system broadcast which sends fixed parameters, and these application programs that are interested in the change of font resources can obtain the newly information on the available font resources only by registering a broadcast receiver with the operation system installed in the equipment.

It can be seen that, the method for changing a font for an application program according to the embodiment of the present invention can conveniently change a font for an application program as needed at any moment. Besides, since the server controls the update and issue of the font resources, the application program does not need to contain and manage the font resources. The Server can update the available font resources as needed at any moment, which provides the application program with more font resources and better user experiences.

Furthermore, it is also possible to make multiple application programs share this method, which can save equipment resources and achieve a convenient centralized management.

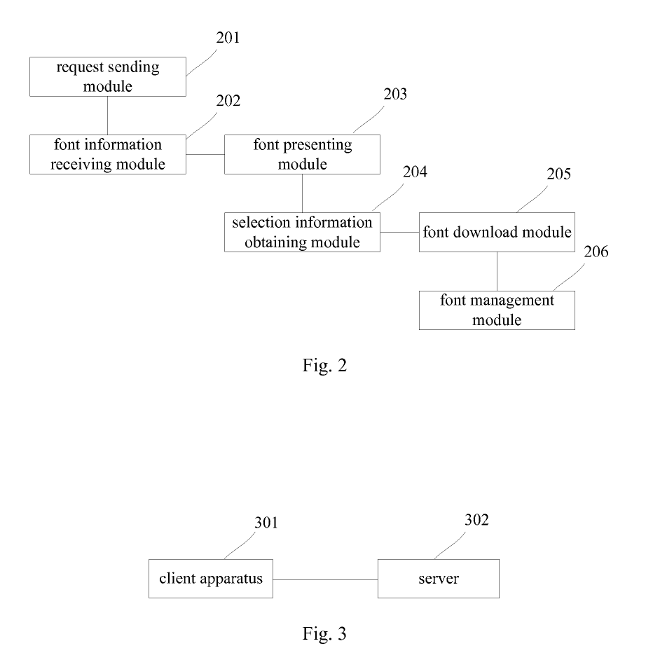

FIG. 2 is a structural schematic of an example client apparatus.

In this example, the client apparatus includes:

a request sending module 201, configured to send a request for obtaining information on available font resources to a server when it is need to change a font for an application program;

a font information receiving module 202, configured to receive information on currently available font resources returned from the server;

a font presenting module 203, configured to present the information on the currently available font resources after the font information receiving module receives the information on the currently available font resources returned from the server;

a selection information obtaining module 204, configured to determine a font selected by a user;

a font download module 205, configured to download the selected font from the server; and

a font management module 206, configured to send the downloaded font downloaded by the font downloading module to the application programs, so that the application program replaces the currently used font with the downloaded font.

The request may include information on fonts that the client currently has, such as the version number of the current font resources, so that the server can determine whether there are new font resources to be issued to the client according to the information. If yes, the server issues only the new font resources to the client; if no, the server notifies the client that there is no the new currently available font resources. In this way, it is possible to avoid repeatedly issuing the font resources that the client has, which saves the network traffic and the loading duration, and improves the user experiences.

The information on the currently available font resources returned by the server may include font style, font typesetting effect, recommend scenes for the font, etc.

In practical applications, the font presenting module 203 mentioned above may adopt multiple methods to present the information on the currently available font resources. For example, the font presenting module may not present pictures but directly present characters by using a small character library extracted from the current character library. Specifically, a section of characters in the small character library can be used to present the font style and the font typesetting effect, and the section of characters contain the recommended scenes. Of course, other presenting methods can be adopted as well, and the presented content is not limited to the above mentioned information.

The font download module 205 mentioned above may support resuming of file transfers, the equipment at the client side can still process other operations without being locked in a wait mode. For example, a thread is started up to download the selected font from the server at the back stage and the downloaded information is managed as a temporary file, so that download is performed by the thread at the back stage and the client may be not locked in the wait mode.

In addition, in practical applications, the font managing module 206 mentioned above can not only send the font downloaded by the font download module 205 to the application program that sends the request to the server directly, but also send the information on the currently available font resources received by the font information receiving module 202 to other application programs that are interested in the change of font resources, for example, send to other application programs by broadcast. These application programs that are interested in the change of font resources can obtain newly information on the available font resources only by registering a broadcast receiver in the application program by the operation system installed in the equipment.

It can be seen that the client apparatus can conveniently change a font for an application program as needed at any moment. Besides, since the server controls the update and issue of the font resources, the application program does not need to contain and manage the font resources. The Server can update the available font resource as needed at any moment, which provides the application program with more font resources and better user experiences.

Furthermore, it is also possible to make multiple application programs share this client apparatus, which can save equipment resources and achieve a convenient centralized management.

FIG. 3 is a structural schematic of a system for changing a font for an application program.

The system can include a client apparatus 301 and a server 302. Wherein, the server is configured to receive a request for obtaining information on available font resources sent by the client apparatus, and send the information on the currently available font resources to the client apparatus after receiving the request.

The structure of the client apparatus can be understood with reference to the foregoing description and the details are omitted.

Communications between the client apparatus 301 and the server 302 could adopt existing standard protocols or self-defined network protocols, the embodiment of the present invention will not limited thereto.

In the system for changing a font for an application program, since the server controls the update and issue of the font resources, the application program does not need to contain and manage the font resources. The Server can update the available font resources as needed at any moment, which provides the application program with more font resources and better user experiences. Furthermore, it is also possible to make multiple application programs share this system, which can save equipment resources, and achieve a convenient centralized management.

It should be noted that the method, apparatus and system for changing a font for an application program described herein can be applied in equipments equipped with different operation systems, provide prolific font resources for the application program running in the equipment, and is simply and expediently to complete the change the font used in the application program.

In some implementations, a computer program product includes computer code for implementing the above mentioned methods for changing a font for an application program.

In some implementations, a non-transitory computer readable medium is configured to store the aforesaid computer program.

The subject matter discussed in the description has been explained in a progressive way, the similar parts described above should be understood by reference to each other, as the description focuses on the difference from previously described implementations. Especially, with respect to embodiments of the apparatus and systems, the description is relatively simple due to the fact they include aspects that are similar to the method, the similarities can be understood with reference to the description of the method. The system described above is only for illustrating, wherein the units described as a separate unit can be or can be not physically separated, an element shown as a unit can be or can be not a physical unit, which means all of them can be located in one location, or could be distributed on multiple units over the Internet. Certain parts or all of the modules could be used to achieve the purpose of the disclosed subject matter according the actual requirements. A person skilled in the art can understand and implement the technical solutions without creative labor.

Example embodiments of the present invention have been described above, and the present invention has been explained using the example embodiments, all of the explanation of the example embodiments is only used to assist one to understand the disclosed method and apparatus; meanwhile, for an ordinary skilled in the art, modifications can be made to the example embodiments as well as the scope of application, therefore, the content of the description should not be understood as a restriction to the present invention in any way.

What is claimed is:

1. A method for changing a font for an application program, comprising:
sending a request for obtaining information on available font resources to a server when it is need to change a font for an application program;
presenting the information on the currently available font information resources after receiving the same from the server;
determining a font selected by a user;
downloading the selected font from the server; and
sending the downloaded font to the application program, so that the application program replaces the currently used font with the downloaded font.

2. The method according to claim 1, wherein
the request comprises information on font resources that a client currently has.

3. The method according to claim 2, wherein
the information on the font resources that the client currently has is a version number of the font resources that the client currently has.

4. The method according to claim 1, wherein
the information on the currently available font resources comprise currently available font style, font typesetting effect and recommended scenes, and
the presenting comprises:
presenting the font style and the font typesetting effect by using a section of characters in a small character database extracted from the current character database, the section of characters contains the recommended scenes.

5. The method according to claim 1, wherein
the downloading comprises:
downloading the selected font from the server by starting up a thread at back stage, and managing the downloaded information as a temporary file.

6. The method according to claim 1, further comprising:
sending the information on the currently available font resources to other application programs by broadcast.

7. A client apparatus, comprising:
a request sending module, configured to send a request for obtaining information on available font resources to a server when it is need to change a font for an application program;
a font information receiving module, configured to receive the information on the currently available font resources returned from the server;
a font presenting module, configured to presenting the information on the currently available font resources after the font information receiving module receives the information on the currently available font resources returned from the server;
a selection information obtaining module, configured to determine a font selected by a user;
a font download module, configured to download the selected font from the server; and
a font management module, configured to sending the downloaded font downloaded by the font downloading module to the application program, so that the application program replaces the currently used font with the downloaded font.

8. The apparatus according to claim 7, wherein
the information on the currently available font resources comprise currently available font style, font typesetting effect and recommended scenes, and
the font presenting module presents the font style and the font typesetting effect by using a section of characters in a small character database extracted from the current character database, the section of characters contains the recommended scenes.

9. The apparatus according to claim 7, wherein
the font downloading module downloads the selected font from the server by starting up a thread at back stage, and manages the downloaded information as a temporary file.

10. The apparatus according to claim 7, wherein
the font management module is further configured to send the currently available font resources received by the font information receiving module to other application programs by broadcast.

11. A system for changing a font for an application program, comprising a client apparatus and a server, wherein
the server is configured to receive a request for obtaining information on available font resources sent by the client apparatus, and send the information on the currently available font resources to the client apparatus after receiving the request.

12. A computer program product comprising computer code for implementing the method according to claim 1.

13. A non-transitory computer readable medium configured to store the computer program product according to claim 12.
